(19) United States
(12) Patent Application Publication
(10) Pub. No.: US 2008/0114690 A1
(43) Pub. Date: May 15, 2008

(54) SYSTEM AND METHOD FOR PERFORMING PARTNER SETTLEMENT FOR MANAGED SERVICES IN AN IP MULTIMEDIA SUBSYSTEM (IMS) NETWORK

(75) Inventors: DEAN M. SKIDMORE, RALEIGH, NC (US); KAUSHAL A. THAKKER, RICHARDSON, TX (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/553,039

(22) Filed: Oct. 26, 2006

(51) Int. Cl. H04L 9/00

(52) U.S. Cl. 705/52

(57) ABSTRACT

The present invention can provide multimedia services by hosting within an Internet Protocol Multimedia Subsystem (IMS) compliant environment of a network operator at least one multimedia service, which is associated with a managed service provider. Instance-specific execution metrics can be determined for instances of the multimedia service. The execution metrics can include resource usage metrics for resources of the IMS compliant environment that are consumed during each of the instances. Revenue generated by the multimedia service instances can be shared between the network operator and the managed service provider based upon the execution metrics in accordance with any revenue sharing agreement established between the network operator and the managed service provider.

### BACKGROUND

1. Field of the Invention

The present invention relates to the field of telecommunications, and, more particularly, to obtaining low level execution metrics for multimedia services executing in an Internet Protocol Multimedia Subsystem (IMS) for partner settlement purposes.

2. Description of the Related Art

Convergence in the telecommunications industry is making multimedia services available today regardless of network, device, and location. There is mounting competition for customers, as historically different network operators are able to compete with each other in a converged marketplace. For example, cable television companies, telephony companies, satellite broadcast companies, and wireless communication companies are able to each provide competing multimedia services. Many believe that differentiation and providing value-added services is the key to successfully competing in the converged marketplace.

One means to competitively provide multimedia services is to partner with third party application service providers, who develop, deploy, and maintain applications that provide multimedia services. These applications can be hosted within a computing environment of a network operator, who charges subscribes for the services. Profits from the services can be shared between the application service providers and the network operator in accordance with previously established revenue sharing agreements. The application service provider that hosts services in their own computing environment or the computing environment of the network operator can be referred to as a managed service provider. The profit sharing arrangement between the managed service providers and the network operators can be said to follow a managed services business model.

The managed services business model can be beneficial to the network operator, the managed service provider, and to subscribers. The network operator is permitted to make services available to consumers without significant risk or in-house development and deployment costs. The managed service provider is granted access to large subscriber populations that can generate revenue by using the hosted services and expensive hardware platforms without facing enormous entry costs for establishing a network infrastructure. The subscribers benefit by being able to receive desired services from a single network operator. Since different managed service providers compete against each other, innovations and value-added services are constantly being made available to the subscribers, where subscriber desires or market-established values for services determine which managed service providers are successful.

The Internet Protocol Multimedia Subsystem (IMS) is standardized reference architecture for delivery of multimedia services to subscribers independent of access and device. An IMS utilizes a 3GPP-compliant version of Session Initiation Protocol (SIP) as signaling protocol and other IP-based protocols such as Diameter for Authentication, Authorization and Accounting (AAA). An IMS supports interworking with existing legacy networks, which include packet-switched and circuit-switched networks. Managed service providers developing applications for an IMS environment can be assured that their applications may be hosted within an infrastructure of any IMS compliant network operator, regardless of infrastructure specifics of the network operator.

When a managed services business model is used in an IMS based environment, the network operator is responsible for tracking service usage, for billing customers, for receiving payment for the services, and for sharing revenue obtained from service customers with managed service providers. These operations can be extremely difficult for a variety of reasons. First, a customer utilized service can be a composite service that utilizes multiple foundations services, where both the composite service and the foundation services can be developed by different managed service providers, each of which is to share in revenue. The difficult services can each have different associated revenue sharing agreements, each basing revenue sharing upon different sharing criteria. Hence, each time a composite service is used, the network operator must determine portions of profit from that service that each managed service provider is to receive in accordance with the sharing agreements.

Revenue sharing agreements and sharing criteria can be based upon relative costs of the network operator for providing the services, upon a relative complexity of the software and hardware that executes the service, and upon the subscriber paid fees. For example, network operators have a higher opportunity cost for providing services that consume significant infrastructure resources, which could be used to provide alternative services. When two service providers provide approximately equivalent services, the provider who provides the services more efficiently to consume fewer resources of the network operators would be rewarded, which is often not the case with conventional implementations.

Managed service providers are often forced to charge fixed per-usage fees for services, regardless of usage complexity. This is detrimental as a market value of a complex service usage can be greater than the value for a basic service usage. If a fixed usage fee is set relatively high, subscribers desiring basic usages can choose not to utilize the service due to cost, which results in a loss of revenue to the managed service provider and the network operator. If a fixed usage fee is set relatively low, subscribers will be receiving services for a significantly lower fee than that which they would be willing to pay, which again results in a loss of revenue to the managed service provider and network operator.

Fixed per usage charges result from a shortcoming with conventional charging mechanisms in existence in circuit switched and packet switched networks. That is, conventional charging implementations deployed in an IMS do no allow for the network operators to track fine-grained resource usage on a per-service instance basis. For example, conventional charging mechanisms, such as Call Detail Records (CDRs) sent to a Charging Collection Function (CCF) or charging events sent to an Event Charging Function (EFC), do no provide detailed execution metrics for the service, which are needed by a network operator for partner settlement and/or subscriber charging based upon resource consumption. As a result, service usage fees are generally no aligned with a market value of the service and are not aligned with a per usage cost (based upon resource consumption) of providing a service.

What is needed is a means for network operators to capture execution metrics of an IMS architecture at a lower granularity level to enable more granular service fees. Revenue sharing between network operators and managed service providers could also be based upon the captured execution metrics. Ideally, network operators can incentivize managed service providers to make efficient use of infrastructure resources by rewarding efficient managed service implementations that conserve infrastructure resources and penalizing inefficient implementations that consume excessive resources.

### SUMMARY OF THE INVENTION

The present invention records execution metrics for instances of multimedia services that execute within an Internet Protocol Multimedia Subsystem (IMS) compliant environment in accordance with an embodiment of the inventive arrangements disclosed herein. The execution metrics can include resource consumption metrics, such as CPU time and/or cycles consumed, bandwidth consumed by data exchanges, storage space consumed, and the like. These metrics permit a relatively fine grained tracking of service usages. Service fees can vary based upon the execution metrics, such as charging greater fees for resource intensive service usages compared to less intensive usages.

When a service instance is a composite service instance that calls one or more low-level multimedia services, which can be referred to as foundation service instances, resources consumed by each of the foundation instances as well as the composite instance can be separately recorded. Revenue sharing can be based at least in part upon execution metrics associated with each service instance, regardless of whether the service instance was executed in a stand-alone fashion for a fee or was executed responsive to a call from a composite service instance.

In one embodiment, Session Initiated Protocol (SIP) private headers can be used to capture the execution metrics. Application servers can extract these metrics from the headers to generate service session detailed records, which can be conveyed to a Service Partner Settlement System. This system can use the execution metrics specified in the service session detailed records to charge subscribers fees that vary in accordance with the execution metrics. The Service Partner Settlement System can also be used to share profits resulting from the multimedia services between a network operator hosting the multimedia services and one or more managed service providers who develop, deploy, and maintain the multimedia services. The revenue sharing can be based at least in part upon the execution metrics.

The present invention can be implemented in accordance with numerous aspects consistent with the material presented herein. For example, one aspect of the present invention can include a method for providing multimedia services. The method can include a step of hosting within an IMS compliant environment of a network operator at least one multimedia service, which is associated with a managed service provider. Instance-specific execution metrics can be determined for instances of the multimedia service. The execution metrics can include resource usage metrics for resources of the IMS compliant environment that are consumed during each of the instances. Revenue generated by the multimedia service instances can be shared between the network operator and the managed service provider based upon the execution metrics in accordance with any revenue sharing agreement established between the network operator and the managed service provider.

Another aspect of the present invention can include a method for capturing service execution metrics. In the method, a Call Session Control Function (CSCF) can obtain a user profile from a Home Subscriber Server (HSS). Execution metric details associated with a multimedia service can be determined from the user profile. The CSCF can add the determined service execution metric details to a SIP header of an INVITE message sent to an application server. The application server can read the service execution metric details from the SIP header. The application server can then capture execution metrics in accordance with the service execution metrics details when executing a service. The application server can convey the captured execution metrics to A Service Partner Settlement System. The Service Partner Settlement System can generate a settlement report for sharing revenue associated with the service executed by the application server. Appointment of revenue shown in the settlement report can be based upon the captured execution metrics.

Still another aspect of the present invention can include a system for providing multimedia services and for sharing revenue for these services with managed service partners based upon execution metrics. The system can include a metrics engine, an application server, and a Service Partner Settlement System. The metrics engine can determine execution metric details for a multimedia service. Revenue for usages of the multimedia service can be shared between a managed service partner and a network operator that hosts the multimedia service based upon execution metric details, which are customized for the multimedia service in accordance with a revenue sharing agreement established between the network operator and the managed service partner. The metrics engine can utilize SIP headers to convey the execution metric details to at least one application server that executes the multimedia service. The metrics engine can extract instance specific execution metrics from SIP headers conveyed from the application server. The application server can execute the multimedia service and can capture execution metrics for the multimedia service. The captured execution metrics can be based upon the execution metric details read from SIP headers. The application server can write captured execution metric values to SIP headers. The Service Partner Settlement System can receive the instance specific execution metrics and can generate at least one settlement report. The settlement report can detail an amount of revenue owed by the network operator to the managed service partner in accordance with the revenue sharing agreement.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distrusted fashion across a network space.

Each method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for providing multimedia services where service fees and/or revenue sharing is based at least in part upon characteristics of service execution in accordance with an embodiment of the inventive arrangements disclosed herein.

FIG. 2 is a schematic diagram of an IMS compliant environment in which managed services are provided in accordance with an embodiment of the inventive arrangements disclosed herein.

FIG. 3 is a schematic diagram of a user profile maintained by a network operator in accordance with an embodiment of the inventive arrangements disclosed herein.

FIG. 4 is a schematic diagram of a system in which execution metrics for multimedia services are captured in accordance with an embodiment of the inventive arrangements disclosed herein.

FIG. 5 is a schematic diagram of a system for providing multimedia services in accordance with an embodiment of the inventive arrangements disclosed herein.

FIG. 6 is a flow chart of a method for capturing and reporting execution metrics for a multimedia service in accordance with an embodiment of the inventive arrangements disclosed herein.

FIG. 7 is a flow chart of a method for revenue sharing for multimedia service based upon execution metrics contained in service session detailed records in accordance with an embodiment of the inventive arrangements disclosed herein.

### DETAILED DESCRIPTION OF THE INVENTION

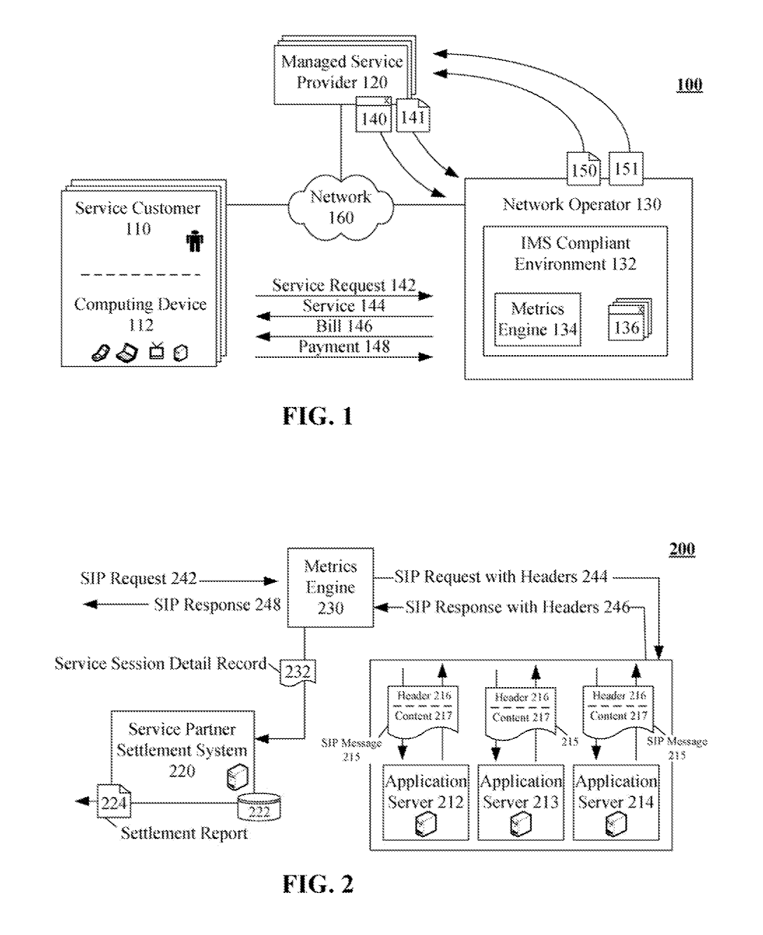

FIG. 1 is a schematic diagram of a system 100 for providing multimedia services where service fees and/or revenue sharing is based at least in part upon characteristics of service execution in accordance with an embodiment of the inventive arrangements disclosed herein. These characteristics can include static and dynamic characteristics, such as central processor unit (CPU) utilization, bandwidth utilization, storage utilization, invoked dependent services, and the like. Capturing execution metrics permits service partners 120 and/or network operators 130 to implement a granular approach for service fees rather than a flat rate for all customers 110 invoking a service 144.

For example, a service customer 110 invoking a service 144 to query stock prices of a day's top and bottom performers can be charged more for invoking the service 144 than a different customer 110, who invokes the service 144 to obtain a quote for a single stock. Revenue sharing between network operator 130 and service partner 120 can be based upon the execution metrics and revenue derived from a managed service.

In system 100, a network operator 130 can provide an Internet Protocol Multimedia Subsystem (IMS) compliant environment 132. Applications 136 can execute within the environment 132, which provide multimedia services to service customers 110. When executing, metrics engine 134 can record metrics pertaining to the executing services on a per-service basis at a relatively low level of granularity, which permits an accounting based upon resource consumptions during an execution instance.

For example, the execution metrics can include bandwidth, central processing unit (CPU) cycles, memory space, data input and/or output, quantity of services provided, total time for providing a service, service options utilized, and the like. When a service is a composite service, a number of subservices called and metrics for each subservice can also be determined and stored by the metrics engine 134. Each subservice, which can include a foundation service, can also track execution metrics using metrics engine 134.

One or more of the applications 136 executing in environment 132 can included service applications 140 created, deployed, and maintained by a service partner 120. A service resulting from application 140 can be referred to as a managed service. Each managed service can have an associated revenue sharing agreement 141, where the network operator 130 and the service partner 120 agree to share revenue generated by a managed service. Revenue sharing criteria specified in agreement 141 can be based at least in part upon execution metrics captured and managed by engine 134. Similarly, the fees that service customers 110 pay for managed services can be based in part upon execution metrics captured by engine 134.

To start a service, a service customer 110 connected to network 160 through a computing device 112 can send a service request 142 to network operator 130. One or more applications 136 that provide the requested service 144 can then execute within one or more application servers (not shown) of environment 132. Applications executed by the application server permits customer 110 to receive the service 144. While the service 144 is executing, resources of environment 132 are consumed. Engine 134 can record important metrics related to service execution. Periodically, a bill 146 for the service 144 can be sent to the service customer 110, who sends a payment 14 to the network operator 130.

Assuming that a managed service of one or more service partners 120 was used to provide the service 144, the network operator 130 can share a portion of the payment 148 with the service provider 120. A Service Partner Settlement System (not shown) can automatically manage partner settlement details. Using the Service Partner Settlement System, the network operator 130 can generate reports 150 that are sent to each service partner 120. Each report 150 can show service usage, service specific metrics, resources expended in provided managed services, payment received, and the. The report 150 can also detail revenue owed the service partner 120 in accordance with the agreement 141. This revenue 151 can be periodically conveyed to the service partner 120.

As shown herein, the IMS compliant environment 132 can use a Voice-over-IP (VoIP) implementation based on a standardized implementation of SIP. The IMS compliant environment 132 can provide access independence by working with any network, fixed, mobile, or wireless. Environment 132 permits services to be provided to service consumers 110 irrespective of their location, access technology, and computing device 112. Additionally, environment 132 can permit a seamless handover of communications between fixed-line and mobile networks.

In one embodiment, the IMS compliant environment can be configured to use a variety of reusable services and service components, which can have runtime customizable behavior. For example, SIP based services and service components of environment 130 can be chained into a SIP dialog at runtime using a Service Capability Interaction Manager (SCIM).

In another embodiment, environment 132 can be implemented in accordance with an International Business Machines Corporation (IBM) Service Architecture. Various technologies compatible with environment 132 can include Web Sphere technologies from IBM, JAVA ADVANCED INTELLIGENT NETWORK INTEGRATED (JAIN) SERVICE LOGIC EXECUTION ENVIRONMENT (SLEE) technologies from jNetX, Service Oriented Architecture (SOA) technologies, JAVA 2 PLATFORM ENTERPRISE EDITION (J2EE) based technologies, and the like. Hence, the services 144 provided by the environment 132 can be implemented in a variety of manners and can support J2EE applications, Web services, and nay type of application that provides IP-based services.

Examples of services 144 implemented by environment 132 include, but are not limited to, VoIP telecommunication services, Push to Talk over Cellular (POC) services, multiparty gaming services, Video On Demand (VOD) services, IP television services, videoconferencing services, messaging services, community services, presence information services, content sharing services, Web browsing services, chat services, email services, instant messaging services, news services, speech processing services, and the like.

FIG. 2 is a schematic diagram of an IMP compliant environment 200 in which managed services are provided in accordance with an embodiment of the inventive arrangements disclosed herein.

In environment 200, a metrics engine 230 can operate as a Session Initiation Protocol (SIP) proxy, which receives SIP messages and adds P-Service-Execution-Metrics and P-Settlement-Function-Address headers within which execution metrics and settlement function address for the composite services are specified. The metrics engine 230 can receive SIP formatted requests 242. Different metrics can be needed for different composite services depending upon business criteria specified in revenue sharing agreements established between the network operator and a service partner. Needed execution metrics and settlement function addresses to support the business criteria mentioned above, for the multimedia service can be specified within SIP headers. The SIP request with headers 244 specifying needed execution metrics and settlement function address can be conveyed to one or more of the application servers 212-214.

Although shown as a component separate from the application servers 212-214, the metrics engine 230 need not be implemented in this manner. In one embodiment, for example, each application server 212-214 can include a server specific engine 230, which can be a binary software module. Prior to deploying a multimedia service into a live environment 200, this binary software module can be configured, deployed and acceptance tested by the network operator.

Regardless of the implementation specifics of engine 230, each of the application servers 212-214 can provide one or more specialized service. IMS services provided by the application servers 212-214 can be classified as foundation services or composite services. Foundation services are stand alone services available via the IMS compliant environment 200, which are often basic services. Foundation services can include, but are not limited to, Presence, Push-to-Talk, Chat, and the like. Composite services can invoke one or more foundation services in an order defined by their service choreography. The network operator needs an SSDR to settle with a managed service provider who provides either a composite or foundation service.

Each application server 212-214, which executes an application in responding to request 242, can receive SIP messages 215. SIP messages 215 can include header 216 information and message content 217. The application servers 212-214 can determine necessary execution metrics from information contained in the P-Service-Execution-Metrics header 216 and can run appropriate execution metric determination programs, such as the binary module of the Metrics Engine, in response to the service invocation request. Resultant metrics can be specified within the headers 216 in fields reserved for metric values. A SIP response with the P-Service-Execution-Metrics filled in header 246 can be conveyed from the application servers 212-214 to the metrics engine 230.

The metrics engine 230, still acting as a SIP proxy, can strip the header information from response 246 and can provide a SIP response 248 to a requestor, if needed. The header information from response 246 can be processed to generate a Service Session Detail Record (SSDR) 232, which details execution metrics consumed by one or more application servers 212-214 in the performance of the lifecycle of one or more services, which were executed to generate the SIP response 248. Different SSDRs 232 can be generated for each foundation service, which includes a detailed breakdown of metrics for that specific service. Each SSDR 232 can be stored in data store 22 of a Service Partner Settlement System (SPSS) 220. In addition, the SPSS also contains other data stores (222) which contain Service Level Agreement (SLAs) for each service which the metrics are compared against to compute the settlement amount. Periodically, records in data store 222 can be processed to generate settlement reports 224, which are sent to managed service partners. The settlement reports 224 can detail partner settlement information, including summary information and detailed service instance-by-instance metrics, which are used to calculate settlement amounts.

In one embodiment, the headers of environment 200 can be private headers, which conform to a SIP standard, such as an Internet Engineering Task Force (IETF) Request for Comments (RFC) 3455 compliant standard. The IETF RFC 3455 standard defines a standard for “Private Header (P-Header) Extensions to the SIP for the 3rd-Generation Partnership Project (3GPP).” The 3GPP standards define a Charging Control Function (CCF) for offline charging whose address is passed during dialog establishment using SIP P-Header extensions (P-Charging-Function-Addresses).

A private header for a charging vector (P-Charging-Vector) is also defined by IETF RFC 3455, which can be used in environment 200. For example, three types of correlation information can be transferred using the P-Charging-Vector; the IMS Charging Identity (ICID) value, the address of the SIP proxy that creates the ICID value, and the Inter Operator Identifiers (IOI). The ICID can be a globally unique charging value that identifies a dialog, or a transaction outside a dialog, which is used to correlate charging records. The first IMS entity in a SIP signaling path can be responsible for assigning the ICID, which is then propagated to all other entities which participate in a communication session associated with SIP request 242.

Environment 200 can also use SIP private header, such as a header named P-Service-Execution-Metrics, to contain values of execution metrics, which are to be captured during service execution. Further, another SIP private header, referred to as P-Settlement-Function-Addresses, can be used to specify an address for the SPSS 220 responsible for generating settlement report 224.

It should be appreciated that the use of private headers is provided as one contemplated embodiment for managing execution metrics for services and that the invention is not limited in this regard. This is, the invention is not limited to an IETF RFC 3455 based standard or even to using SIP headers, and any standard an be used that is capable of conveying needed execution metrics to application servers 212-214 and receiving values for these execution metrics in return.

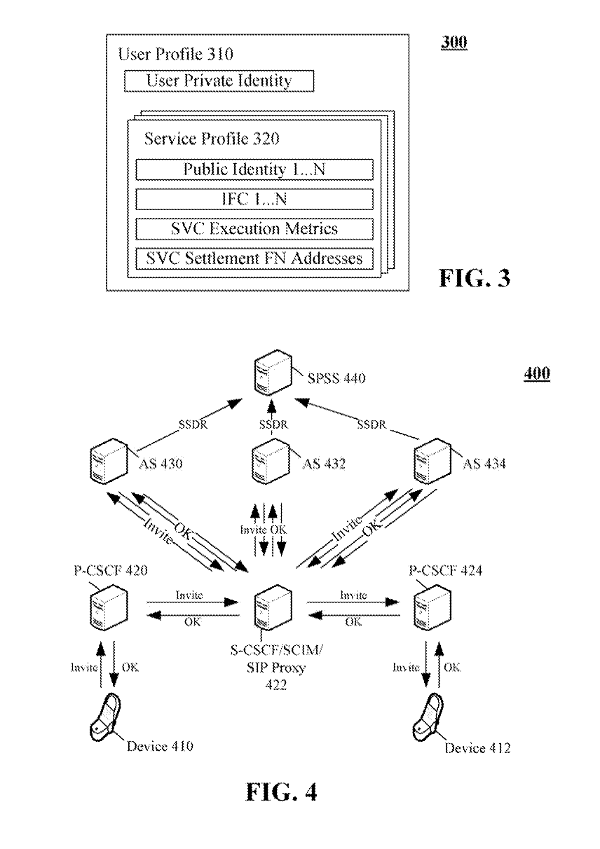

FIG. 3 is a schematic diagram 300 of a user profile 310 maintained by a network operator in accordance with an embodiment of the inventive arrangements disclosed herein. The user profile 310 can be a record containing subscription-related information that is maintained by a home subscriber server (HSS). The HSS can be a master user database that supports the IMS network entities that handles calls, sessions, and services. Thus, the HSS can support the network operator 130 of FIG. 1 and/or can support environment 200 of FIG. 2.

The user profile 310 in the Home Subscriber Server (HSS) can include a private identity that can uniquely associated with a user. Existing standardized identity attributes can be used as the user private identity. For example, an International Mobile Subscriber Identity (IMSI) and/or an International Mobile Equipment Identity (IMEI), which are standards used in normal 3GPP networks, can be used as the private identity. The IMSI is a unique identity that is typically stored in a Subscriber Identity Module (SIM) card of a mobile device. The IMEI is a device specific identity that is device specific instead of user specific. Other unique values can be used as the user private identity, such as an IP Multimedia Private Identity (IMPI), and the invention is not construed as limited in this regard.

The user private identity is converted into a public identity that is part of a service profile 320 for privacy reasons. Multiple different public identities can exist within the service profile 320. For example, a public identity can include a mobile subscriber ISDN Number (MSISDN), which is a telephone number of a user. A different public identify can include an email address of a user, a subscriber identification number used for billing purposes, a Temporary Mobile Subscriber Identity (TMSI), and the like.

The service profile 320 can include execution metrics. The execution metrics can vary on a service-by-service basis, which allows different metrics to be associated with different services. When a Serving-Call Session Control Function (S-CSCF) downloads the user profile 310 from a HSS, the S-CSCF can determine which execution metrics corresponds to which services. The S-CSCF can then insert suitable information into SIP headers to define which execution metrics are needed. For example, a new SIP header named P-Service-Execution-Metrics header can be used to contain values of execution metrics, which should be captured by the binary module of the Metrics engine running in the application servers during service execution.

The P-Service-Execution-Metrics header can include values for CPU Time (CPUT), Input/Output Data (IODAT), Storage Utilization (DISKU), External Services Used (EXTSVC), and the like. CPUT can be a time from a service request to a response. IODAT can include characteristics of data input/output during service execution, such as data input/output volume, size, and nature. The EXTSVC can capture a use of external services within main service execution. For example, EXTSVC can record each foundation service executed for a composite service.

The service profile 320 can also include service settlement function addresses. These addresses can uniquely identity a node of a SPSS, which can process execution metrics for the services and responsively determine usage fees and/or partner settlement amounts. In one embodiment, a new SIP header named P-Settlement-Function-Addresses header can be used to contain one or more addresses for the SPSS. For example, the P-Settlement-Function-Addresses header can include hostnames and/or network addresses of SPSS nodes which are configured to receive various Service Session Detailed Records (SSDRs) from nodes that are in an execution path of a related multimedia service.

FIG. 4 is a schematic diagram of a system 400 in which execution metrics for multimedia services are captured in accordance with an embodiment of the inventive arrangements disclosed herein. The system 400 can be one operational example that is consistent with components shown in system 100 and environment 200.

System 400 can conform to 3GPP standards, such as standards (e.g., an RFC 3455 based standard) established for offline charging. In one embodiment, P-Charging-Vector can be used, where the P-Charging-Vector can include a collection of charging information. The charging information can include, for example, an ICID value, an address of a SIP proxy that creates an ICID value, and an IOI. The SIP proxy can be a proxy that handles metrics-specific SIP headers. Application servers can receive SIP messages that include these metrics-specific headers. In addition to 3GPP standardized headers, system 400 can utilize new metrics-specific headers, Such as a P-Service-Execution-Metrics header and/or a P-Settlement-Function-Addresses header.

In system 400, a device 410 can initiate an INVITE message, which is sent to Proxy-Call Session Control Function (P-CSCF) 420. P-CSCF 420 can convey the INVITE message to S-CSCF 422, which had previously downloaded a user profile in accordance with diagram 300 from an HSS during registration. From the user profile, the S-CSCF 420 can determine which execution metrics correspond to which services. Then the S-CSCF 420 can insert a P-Service-Execution-Metrics header and a P-Settlement-Function-Addresses header into SIP signaling information, where the headers include the profile provided information. The SIP INVITE messages with the two new P-Headers can then be sent from the S-CSCF, Service Capability Interaction Manager (SCIM) or SIP Proxy 422 to application servers 430, 432, and 434, which provide the services requested by device 410. Header information included in the INVITE messages can be processed by the application servers 430-434 so that each application server 430-434 is aware of needed service execution metrics.

The S-CSCF can then send an INVITE message to the P-CSCF-424, which conveys an INVITE message to device 412. Device 412 can convey an OK message to P-CSCF 424, which is conveyed to S-CSCF 422. The OK message is conveyed to application servers 430-434, and then to device 410. A multimedia session can now execute, which involves communication between 410 and 412 and uses services provided by AS 430-434. Once the multimedia session ends, each of the application servers 430-434 can convey SSDRs that contain execution metrics for the multimedia session to a SPSS 440. The SPSS 440 can use execution metrics recorded for the multimedia service to determine subscriber fees and/or for managed partner settlement purposes.

In one embodiment, a network operator can provide each application service 430-434 with a binary software program named SSDR generator before a managed service is deployed within a service environment. The SSDR generator can capture appropriate run-time metrics from service execution and can generate a SSDR. The SSDR can be dispatched to an address of the SPSS, which is specified in a P-Settlement-Function-Addresses header. The generated SSDR can include a P-Settlement-Function-Addresses header, and a P-Charging Vector header. The SPSS can use the ICID to correlate multiple SSDRs that are related to a multimedia session. Once the SSDRs are correlated, partner settlement reports can be generated and sent to managed service providers.

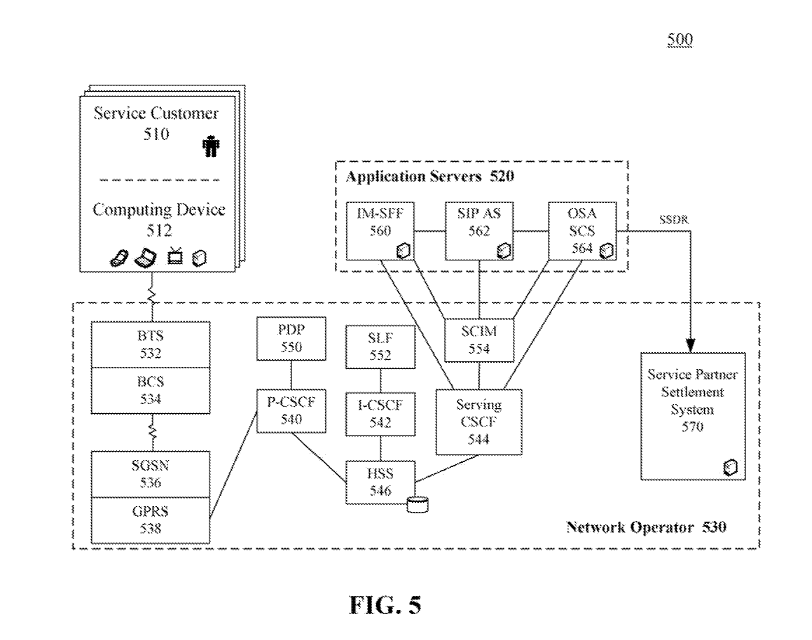

FIG. 5 is a schematic diagram of a system 500 for providing multimedia services in accordance with an embodiment of the inventive arrangements disclosed herein. System 500 is one specific embodiment of system 100.

In system 500, a service customer 510 can subscribe to at least one multimedia service provided by network operator 530. The service can be one that is developed by a managed service provided and deployed within an application server 520.

Base Transceiver Station (BST) 532 can terminate a radio interface involving computing device 512, which can be a mobile station. Base Station Controller (BSC) 534 can control frequency administration and handover. Serving General Packet Radio Service (GPRS) Support Node (SGSN) 536 can keep track of a location of individual mobile stations and can perform security functions and access control. Gateway GPRS Support Node (GPRS) 538 can support the edge routing function of the GPRS network.

P-CSCF 540 can be an IMS element that is identified as a first contact point for device 512 within an IM core network subsystem. I-CSCF 542 is an IMS element that provides a contact point within an operator's network. Serving CSCF 544 can provide session control for subscribers, such as customer 510, that access services within the IM. HSS 546 can be a master user database that supports the IMS network entities that handle calls/sessions. HSS 546 can contain subscription related user profiles, can perform authentication and authorization of customer 510, and can provide information about the physical location of customer 510.

Policy Decision Point (PDP) 550 can obtain authorization tokens as needed. Subscriber Location Function (SLF) 552 can be utilized when multiple HSS 546 are utilized by network operator 530. SCIM 554 can orchestrate service delivery among application servers 520 within the IM architecture.

Application servers 520 can host and execute services, and can interface with the servicing CSCF 544. This allows managed service provides an easy means to deploy value added services into the IMS infrastructure of the network operator 530. SIP Application Server (AS) 562 can be any native IMS application server. Open Service Access (OSA) Service Capability Server (SCS) 564 can interface with an OSA compliant application server using Parlay. IM Service Switching Function (IM-SFF) 560 can interface with Customized Applications for Mobile networks Enhanced Logic (CAMEL) compliant application server using a CAMEL Application Part (CAP). Each application server 520 can convey SSDRs to service partner settlement system 570.

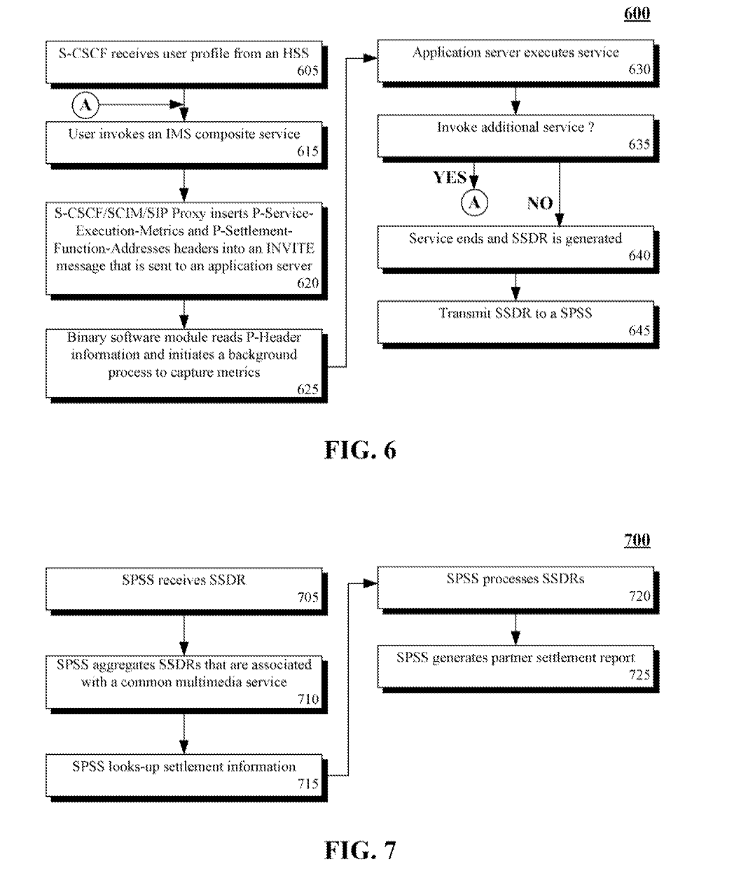

FIG. 6 is a flow chart of a method 600 for capturing and reporting execution metrics for a multimedia service in accordance with an embodiment of the inventive arrangements disclosed herein. The method can be performed in the context of a system 100 or an environment 200. Method 600 describes a specific embodiment wherein binary software modules (metrics engines) associated with individual application servers handle execution metrics related operations. The invention is not to be construed as limited in this regard and derivative embodiments are contemplated where the metrics engine is implemented in a different fashion.

Method 600 can begin in step 605, where an S-CSCF receives a user profile from an HSS when the user registers. The user profile can contain one or more service profiles. Each service profile can include service execution metrics needed for the associated service and a service settlement function address that uniquely identifies a SPSS to which service session detail records are to be transmitted. In step 615, a user can invoke an IMS composite service.

In step 620, the S-CSCF/SCIM/SIP Proxy can insert new P-Headers in an INVITE message to the application server which hosts a first service in the choreography executed for the composite service. P-Service Execution Metrics and P-Settlement Function addresses can be sent in the INVITE message that is sent from the S-CSCF/SCIM/SIP Proxy to each application server. In step 625, a binary software application in the module server can read the information in the P-Headers and can initiate background processes to capture needed execution metrics. These background processes can be initiated prior to service execution. In step 630, the service an execute. In step 635, the service can optionally invoke an additional service. When a new service is invoked, the method can loop to step 620, where the CSCF can insert P-Headers in an INVITE message sent to an application server that hosts the additional service. In step 640, the service can end. Upon ending, a SSDR can be generated based upon the captured metrics. In step 645, the SSDR can be conveyed to a SPSS.

It should be noted that the binary software module of step 625 can be delivered prior to the multimedia service going live and is delivered in binary format to maintain integrity of SSDR generation and thus prevent fraud. Because the execution metrics captured by the binary software application will influence revenue paid to a managed service provider, the network operator or some independent trusted party can provide and/or validate the code of the binary software module.

FIG. 7 is a flow chart of a method 700 for revenue sharing for multimedia service based upon execution metrics contained in service session detailed records in accordance with an embodiment of the inventive arrangements disclosed herein. The method 700 can include steps executed by a SPSS. Method 700 can be performed in the context of a system 100 or environment 200. The service session detailed records used in method 700 can be generated by the steps detailed in method 500.

Method 700 can begin in step 705, where a SPSS can receive one or more SSDRs associated with a multimedia service. The SSDRs can be generated by application services and/or any metrics engine that captures execution metrics of application servers after service execution. In step 710, the SPSS can aggregate SSDRs for the same composite service. A unique identifier, such as an ICID, that is included in the SSDRs can be used to determine which services were executed for the composite service. In step 715, the SPSS can look-up settlement information contained within a database that details contractual specifics for revenue sharing established between the network operator and the managed service partner. In step 720, the execution metrics can be processed in accordance with the settlement information. In step 725, a partner settlement report can be generated, which shows an amount owed by the network operator to the managed service provider. The generated SSDR must include the P-Charging-Vector information including ICID so that the SPSS can use the ICID for correlation of multiple SSDRs related to the same session.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that is carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. A method for providing multimedia services comprising:
hosting within an Internet Protocol Multimedia Subsystem (IMS) compliant environment of a network operator at least one multimedia service, each multimedia service being associated with a managed service provider;
determining instance-specific execution metrics for instances of said at least one multimedia service, said execution metrics including resource usage metrics for resources of the IMS compliant environment that are consumed during each of the instances; and
sharing revenue generated by the multimedia service instances between the network operator and the managed service provider based upon the execution metrics.

2. The method of claim 1, wherein said at least one multimedia service comprises a plurality of multimedia services, each of the plurality of multimedia services being associated with a different managed service provider.

3. The method of claim 2, wherein said instances are instances of a composite multimedia service, said composite multimedia service comprising said plurality of multimedia services, wherein said instance-specific execution metrics are determined for the composite multimedia service and for each of said plurality of multimedia services on a per-service and on a per-instance basis.

4. The method of claim 2, wherein different execution metrics are associated with different ones of the plurality of multimedia services, wherein the different execution metrics and revenue sharing details for each of the multimedia services are based upon revenue sharing contracts established on a per-service-basis between the network operator and the different managed service providers.

5. The method of claim 1, wherein the execution metrics comprise metrics for at least one of the following: Central Processing Unit (CPU) time from a service request to a corresponding response, data input during execution of said multimedia service, data output during execution of said multimedia service, storage space used during execution of said multimedia service, and use of external services while executing said multimedia service.

6. The method of claim 1, wherein the execution metrics are stored within Session Initiated Protocol (SIP) headers associated with each of the instances.

7. The method of claim 6, wherein the Session Initiated Protocol headers are private headers.

8. The method of claim 7, wherein the private headers conform to an Internet Engineering Task Force (IETF) Request for Comments (RFC) 3455 based standard.

9. The method of claim 1, further comprising:
executing a background process prior to service execution in each application server that provides one of said at least one multimedia service; and
said background process capturing said execution metrics.

10. The method of claim 9, further comprising:
said background process reading at least one Session Initiated Protocol header to determine execution metrics applicable for said multimedia service provided by the application server in which the background process executes, wherein different execution metrics are defined for different multimedia services.

11. The method of claim 10, further comprising:
receiving a user profile from a Home Subscriber Server (HSS);
using the user profile to determine execution metrics applicable to a multimedia service; and
writing the applicable execution metrics to said Session Initiated Protocol header.

12. The method of claim 11, wherein a Serving-Call Session Control Function (S-CSCF) performs the writing step, wherein said Session Initiated Protocol Header is part of a Session Initiated Protocol INVITE message sent to the application server.

13. The method of claim 1, further comprising:
identifying at least one application server that provides one of said at least one multimedia service;
each application server capturing execution metrics for a service, which the application server provides;
recording the captured execution metrics in Session Initiated Protocol headers;
extracting the recorded execution metrics from the Session Initiated Protocol headers;
conveying the extracted execution metrics to a service partner settlement system; and
the service partner settlement system utilizing the execution metrics to automatically generate settlement reports, which detail revenue owed to the managed service provider by the network operator.

14. The method of claim 13, further comprising:
extracting a network address from the said Session Initiated Protocol headers for the service partner settlement system, wherein the conveying step conveys the extracted execution metrics to the network address.

15. The method of claim 1, wherein said steps of claim 1 are steps performed automatically by at least one machine in accordance with at least one computer program having a plurality of code sections that are executable by the at least one machine.

16. The method of claim 1, wherein the steps of claim 1 are performed by at least one of a service agent and a computing device manipulated by the service agent, the steps being performed in response to a service request.

17. A method for capturing service execution metrics comprising:
a Call Session Control Function (CSCF) obtaining a user profile from a Home Subscriber Server (HSS);
determining service execution metric details associated with a multimedia service from the user profile;
the Call Session Control Function adding the determined service execution metric details to a Session Initiated Protocol header of an INVITE message sent to an application server;
the application server reading the service execution metric details from the Session Initiated Protocol header,
the application server capturing execution metrics in accordance with the service execution metrics details when executing a service;
the application server conveying captured execution metrics to a service partner settlement system; and
the service partner settlement system generating a settlement report for sharing revenue associated with the service executed by the application server, wherein apportionment of revenue shown in the settlement report is based upon the captured execution metrics.

18. The method of claim 17, wherein the application server writes the captured service execution metrics to a Session Initiated Protocol header, and wherein a network address for the service partner settlement system is included in a Session Initiated Protocol header.

19. The method of claim 17, wherein the steps of claim 17 are performed by at least one of a service agent and a computing device manipulated by the service agent, the steps being performed in response to a service request.

20. A system for providing multimedia services and for sharing revenue for these services with managed service partners based upon execution metrics, said system comprising:
a metrics engine configured to determine execution metric details for a multimedia service, wherein the execution metric details are customized for the multimedia service in accordance with a revenue agreement established between the network operator and the managed service partner, wherein said metrics engine is configured to utilize Session Initiated Protocol headers to convey the execution metric details to a least one application server that executes the multimedia service, and wherein said metrics engine is configured to extract instance specific execution metrics from Session Initiated Protocol headers conveyed from the application server;
the application server configured to execute said multimedia service and to capture execution metrics for the multimedia service, wherein captured execution metrics are based upon the execution metric details read from Session Initiated Protocol headers, and wherein said application server is configured to write the captured execution metric values to Session Initiated Protocol headers, wherein said execution metric values are said extracted instance specific execution metrics; and
a service partner settlement system configured to receive the instance specific execution metrics and to generate at least one settlement report based upon the instance specific execution metrics, wherein said settlement report includes an amount of revenue owed by the network operator to the managed service partner in accordance with the revenue sharing agreement.
